(19) United States
(12) Patent Application Publication
(10) Pub. No.: US 2026/0053169 A1
(43) Pub. Date: Feb. 26, 2026

(54) Method for Producing Protein Crisps and Products Produced Thereby

(71) Applicant: Glanbia Nutritionals Limited, Twin Falls, ID (US)

(72) Inventors: Brent L. Petersen, Twin Falls, ID (US); Mark A. Stout, Twin Falls, ID (US); Michael Young, Twin Falls, ID (US)

(21) Appl. No.: 18/811,912

(22) Filed: Aug. 22, 2024

(51) Int. Cl. A23J 3/26; A23J 3/14; A23J 3/16; A23L 29/00

(52) U.S. Cl. CPC A23J 3/26; A23J 3/14; A23J 3/16; A23L 29/035; A23L 29/05

(57) ABSTRACT

Disclosed is a method for extruding protein-based doughs to form protein-based crisps, the method being particularly effective for decreasing variability in the extrusion of pea and other plant protein-based doughs to produce pea and other plant protein-based crisps that have a light, less dense texture. The method utilizes the synergistic effect of the addition of lecithin and at least one acidulant to the dough ingredients to promote gel formation early in the extrusion process.

### FIELD OF THE INVENTION

The invention relates to methods for extruding protein-based doughs to form protein-based crisps. More specifically, the invention relates to methods for decreasing variability in the extrusion of pea and other plant protein-based doughs to produce pea and other plant protein-based crisps.

### BACKGROUND OF THE INVENTION

Extrusion cooking is a process by which moistened starchy and/or proteinaceous materials with expansile properties are plasticized in an elongated chamber using a combination of moisture, heat, pressure, and mechanical shear, elevating the temperature of the product within the tube, gelatinizing starches and denaturizing proteins. The extruder barrel, screws and die align the molecules in the direction of flow, exposing and aligning bonding sites that produce crosslinking and an expanded structure that is generally referred to as a “puff,” or “crisp.” Generally, especially when pea protein is used to form the crisp, it is rather dense and fibrous/tough or brittle.

Pea protein concentrates can be difficult to extrude, and mixtures of pea protein concentrates having similar protein, fat, starch, and ash contents can behave quite differently in extruders-creating inconsistency that affects extrusion speeds, surging, and sporadic puffing, as well as variable air bubble size, inconsistent texture, and inconsistent surface area (which makes drying more difficult). This inconsistency seems to be more pronounced with pea-derived protein ingredients, as it is not generally seen when using, whey protein concentrates and/or isolates, and milk protein concentrates and/or isolates. As pea protein levels increase, it becomes more and more difficult to achieve the desired textural properties in extruded crisps and to control the variability that appears to be inherent in the use of pea protein.

Extrusion efficiency is assessed by ease of flow of product through the extruder, lack of extruder clogging, lack of surging or significant speed variation, consistency of production of extruded products having similar size and shape, maintenance of small, even air pockets, and consistent desirable textural characteristics in the extruded product (glassy, not chewy, soft, evenly-distributed small air pockets, not too crunchy, etc.). Variables such as apparent viscosity impact the size of the air pockets or bubbles, and pH can impact protein solubility. Managing these variables to produce high protein crisps which are light and airy has proven to be challenging. In short, it is not easy to produce commercially useful high protein crisps, particularly non-dairy protein crisps including pea, faba and soy crisps.

Extruded protein crisps can be used as ingredients in a wide variety of products-such as granolas, cereals, snack bars, nutrient-dense energy bars, and confections—to provide added protein, as well as functionality. One can imagine that lighter, less dense crisps could be more useful in many of these products than would very crunchy, very dense crisps. However, the denser version of crisp is generally associated with pea protein because it is harder to produce the lighter version with pea protein.

By way of examples of two different types of products of different density and texture that are produced by extrusion cooking, one can look at the distinctions between the light, airy “cheese puffs” sold as snack foods and the more dense and crunchy products sold in the pet food industry as “kibble.” U.S. Pat. No. 4,517,204 (assigned to Frito Lay Inc.) describes the way that familiar puffed snack products, such as those sold under the Cheetos® brand name, are made. Generally, a batter is formed of meal or flour and other ingredients, and the batter is cooked in an extruder to a temperature and pressure at which the mixture will “puff” or expand when it reaches atmospheric pressure as it exits the extruder. The extrusion is then cut to form collets and fried or baked to reduce the moisture content of the collets, which are subsequently flavored by being coated with a slurry containing oil and flavoring such as cheese powder. Another type of extruded product is what is commonly known as dog or cat food kibble. One source describes its production as (1) mixing ingredients and grinding them to form a dough, (2) pushing the dough through the inside of an extruder where it is continually mixed by the extruder screw(s) while being heated under pressure to temperatures of up to and sometimes even over 150° C., and (3) pushing the dough through a die. As the cooked and shaped dough leaves the pressure of the extruder through the die, it expands quickly while it is continually sliced by a rotating knife to form individual pieces, which are dried to form the kibble product. (See www.allaboutdogfood.co.uk/articles/dry-dog-food-the-cost-of-convenience.php.) Both of these products are produced by extrusion cooking, but the combination of ingredients and the cooking conditions produce considerably different products.

Formulators have spent considerable time and money trying to solve the problem of pea protein extrusion variability and to develop crisps that are lower in density, lighter, and more stable. In other words, considerable effort has been made toward producing crisps that are less like dog kibble and more like light, delicately crispy snack products.

Another very economically significant issue that can arise in the making of protein crisps, as the result of extrusion variability, is product variability that is significant enough to result in considerable levels of product and material waste. Materials that are used to produce undesirable products are effectively wasted, as are the space, energy, and personnel time associated with making those products. Products such as these can retail for about $20 USD per pound, so the loss of potential profits can be quite significant.

What have still been needed up to this point are better formulas and methods for extruding crisp products containing pea and other plant protein to increase protein levels, reduce extrusion and product variability, and produce lighter, more stable, softer crisps.

### SUMMARY OF THE INVENTION

The invention relates to a method for producing extruded protein crisps from pea and other plant proteins (e.g., faba, soy, flax, and canola protein) that have a lighter, less dense texture than that of conventional extruded pea protein crisps. The method comprises adding to at least one pea or other plant protein component an effective amount of lecithin and at least one acidulant to produce, with the addition of water, a dough which develops sufficient early viscosity and gel formation in the proximal end of an extruder barrel to reduce gel tearing as the dough is moved through the extruder barrel toward at least one die at the distal end of the extruder barrel.

In various aspects, the at least one acidulant is citric acid. In various aspects, an effective amount of acidulant is at least 0.5 percent citric acid. In various aspects, an effective amount of acidulant is at least 1.0 percent citric acid. The type of acidulant used can include any acidulant known to those skilled in the art, including but not limited to citric acid, phosphoric acid, lactic acid, fumaric acid, calcium citrate, malic acid, potassium citrate, sodium citrate and tartaric acid.

In various aspects, the dough comprises at least about 55 percent protein. In various aspects, the dough comprises at least about 65 percent protein. In various aspects, the dough comprises at least about 70 percent protein. In various aspects, the dough comprises at least about 75 percent protein.

In various aspects, the lecithin is soybean lecithin. The type of lecithin used is not restricted to soybean lecithin but could include any lecithin known to those skilled in the art, including but not limited to soybean lecithin, canola lecithin, and sunflower lecithin. In some aspects of the invention, a source of fiber and/or starch is added to the dough. In various aspects the plant protein component is a pea protein concentrate comprising pea protein, pea fiber, and/or pea starch. In various aspects the plant protein component is a faba protein concentrate comprising faba protein, faba fiber, and/or faba starch. In various aspects the plant protein component is a soy protein concentrate comprising soy protein, soy fiber, and/or soy starch.

The invention also relates to a method for promoting the formation of gels during extrusion of at least one dough comprising at least about 98% percent pea protein concentrate, the method comprising adding to at least one pea protein component an effective amount of lecithin and at least one acidulant to promote gel formation upon the addition of water and heat to the dough ingredients.

In another aspect of the invention the extruded product can be milled to effectively reduce its particle size to produce a high protein powder to be used in various high protein applications.

### BRIEF DESCRIPTION OF THE DRAWINGS

FIG. 1 is a bar/column graph illustrating the differences in product density when the indicated combinations of ingredients are used to produce pea-protein-based crisps under similar extrusion conditions in a side-by-side comparison. Columns 1 and 2 represent the density of control products made without the addition of either lecithin or citric acid. The two products were made at different times. Column 3 represents the density of a product made with the addition of lecithin. Column 4 represents the density of a product made by adding citric acid. Column 5 represents the density of a product made by adding both lecithin and citric to the ingredients used to make the dough for the protein crisp.

FIG. 2 is a photograph of the Control product (no lecithin, no citric acid) corresponding to column 1 of the graph in FIG. 1.

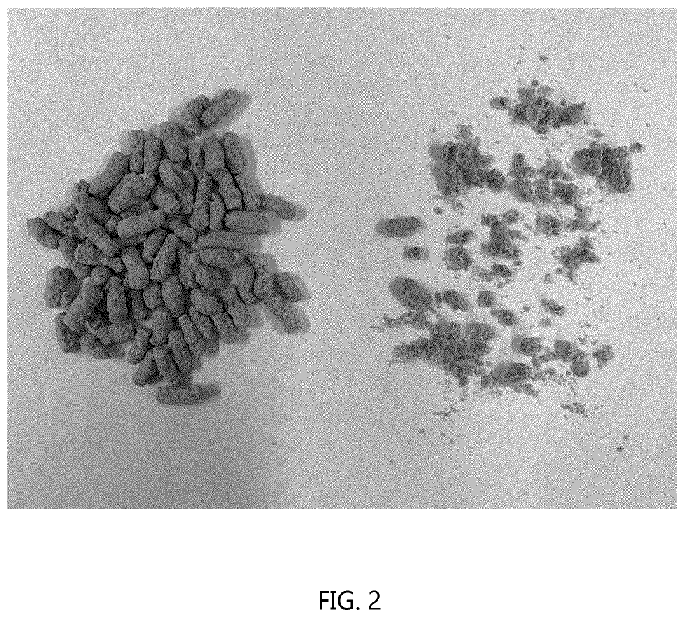

FIG. 3 is a photograph of the Control product (no lecithin, no citric acid) corresponding to column 2 of the graph in FIG. 1.

FIG. 4 is a photograph of a product made by the addition of lecithin to the dough used to make the protein crisp, corresponding to column 3 of the graph in FIG. 1.

FIG. 5 is a photograph a product made by the addition of citric acid to the dough used to make the protein crisp, corresponding to column 4 of the graph in FIG. 1.

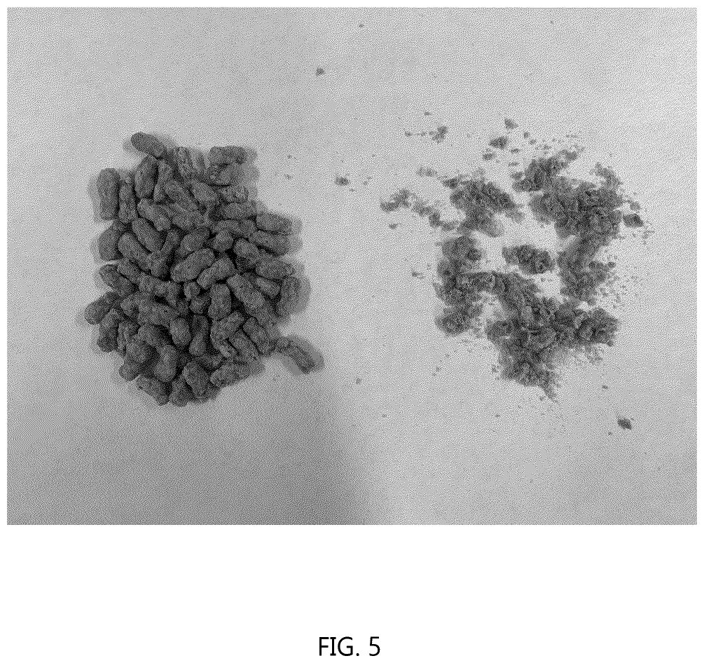

FIG. 6 is a photograph a product made by the addition of both lecithin and citric acid to the dough used to make the protein crisp, corresponding to column 5 of the graph in FIG. 1.

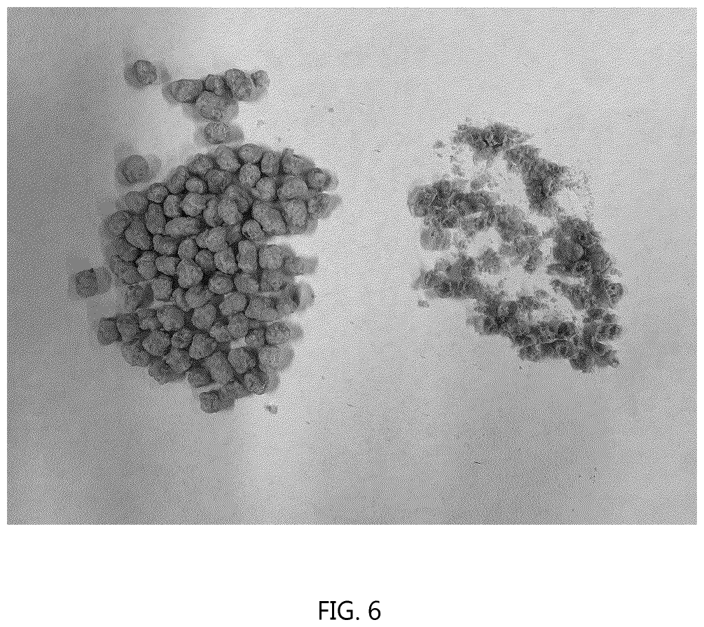

FIG. 7 is a graph illustrating the effect on dough viscosity over time when the pH is adjusted by the addition of citric acid.

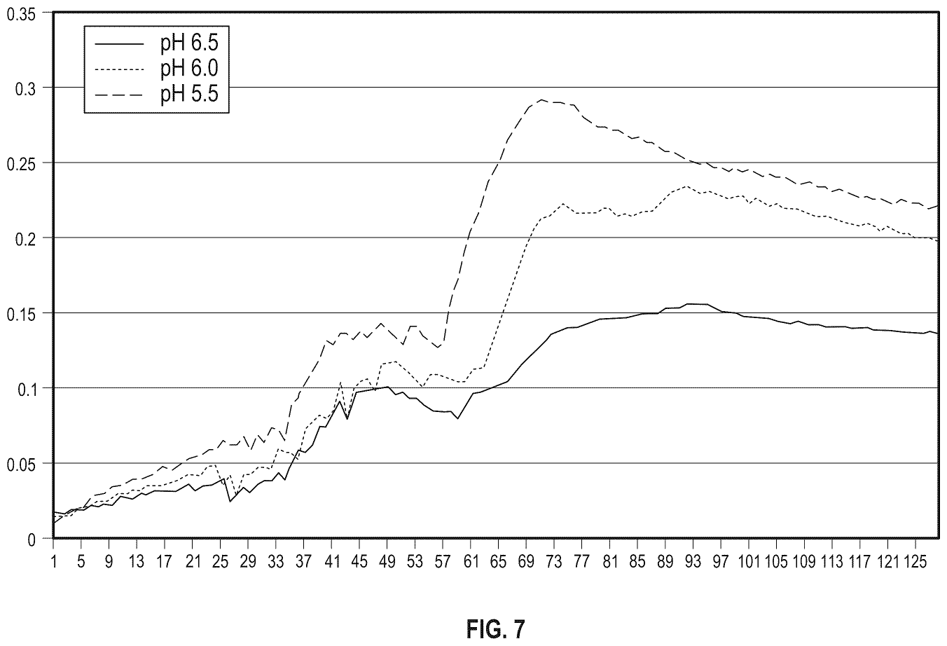

FIG. 8 is a graph illustrating the effect on dough viscosity over time by the addition of the indicated levels of lecithin.

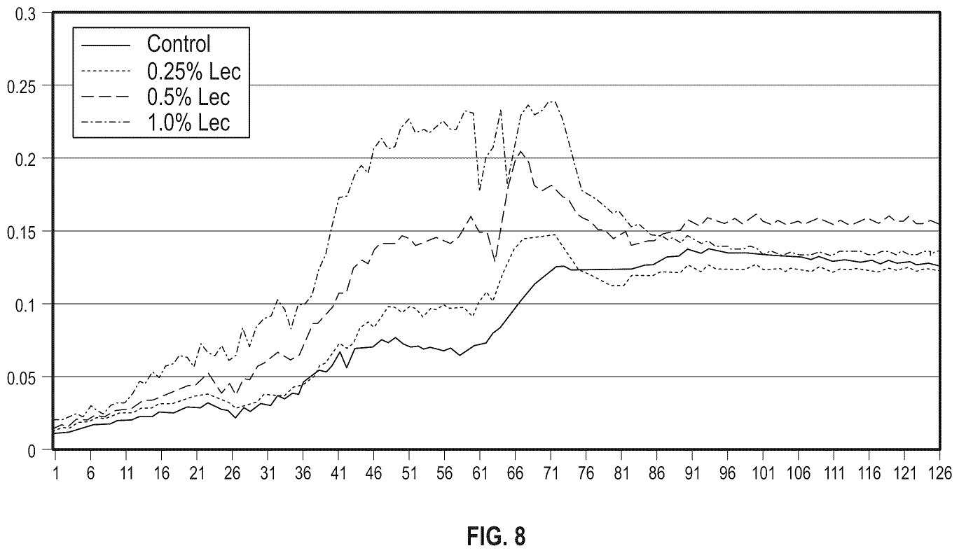

FIG. 9 is a graph illustrating the effect on dough viscosity over time by the addition of the indicated levels of citric acid and lecithin.

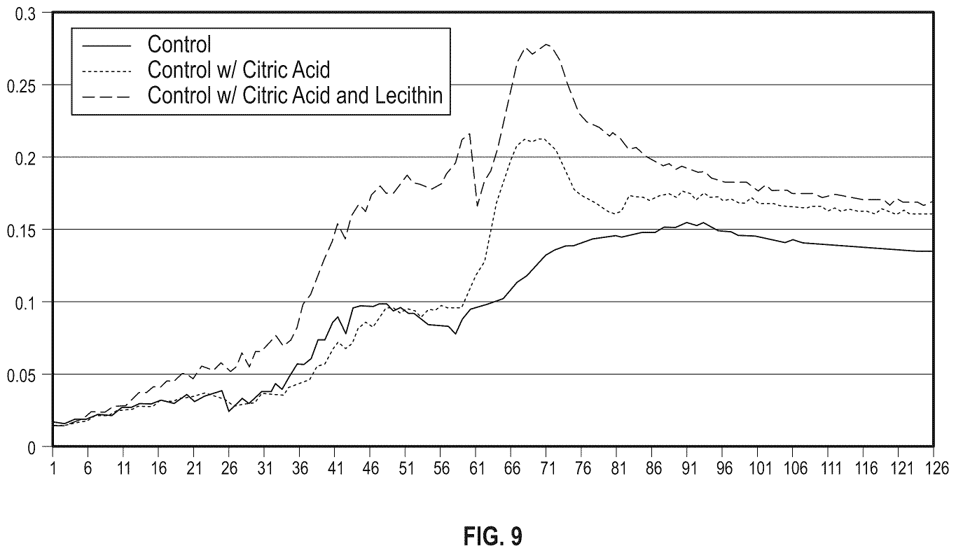

### DETAILED DESCRIPTION

The inventors have developed a new method for producing protein crisps using pea and other plant protein, the method producing crisps that are lighter and more stable, while significantly reducing extrusion variability and providing more reliable and consistent results from the extrusion process. The method utilizes the combination of lecithin and an acidulant to modify the protein dough during extrusion to provide the desired result.

In typical extrusion situations, lecithin promotes solubility and improves moisture binding, but can also tend to increase the density of the product. Increasing mechanical energy and heat also seems to encourage development of a thicker cell wall, with associated glassiness, grit, and hard texture-even in lighter products. The addition of acidulants can have varied outcomes in extrusion. As pH of a product is modified prior to extrusion, its viscosity, melt temperature, and likelihood of burning are all impacted. Thus, pH modification can impact different ingredients and blends in dramatically different ways. For example, pea protein concentrate tends to have decreased solubility at lower pH. Extruded pea protein also tends to have increased gelling affinity and higher viscosity at lower pH. Increased gelling affinity and higher viscosity would generally cause a crisp to be denser, have a harder shell, and be less stable during extrusion, so intuitively it should make sense to increase the pH of pea protein to encourage a lighter puffed product.

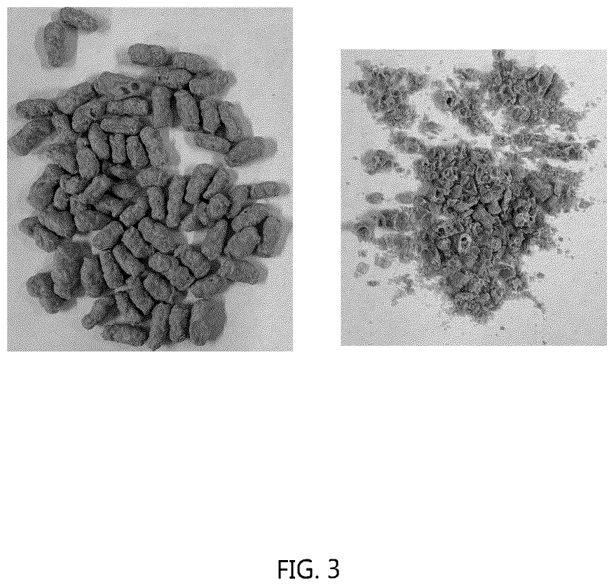

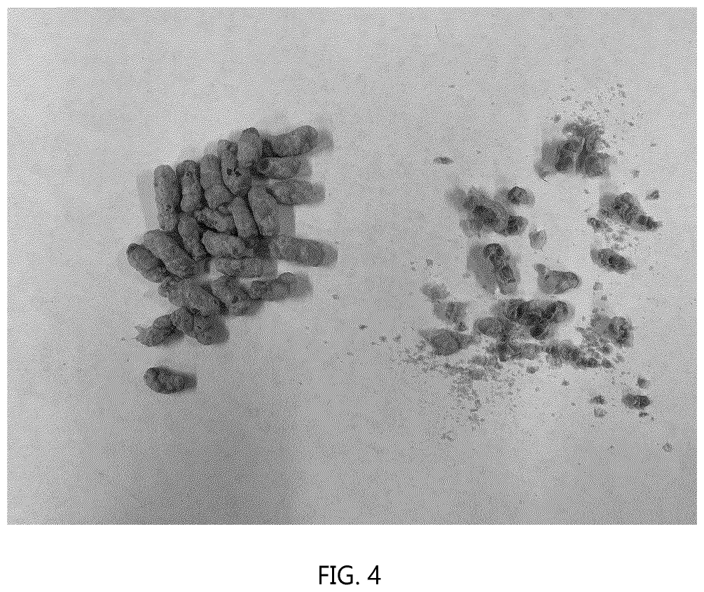

As shown in FIG. 3 and FIG. 4, lowering the pH of pea protein concentrate in an extruder promoted the formation of a denser, harder, glassier crisp. However, as demonstrated by the photograph of a pea protein crisp made using a combination of acidulant (e.g., citric acid) and lecithin, according to the method of the invention, the two ingredients together appear to complement each other to create a unique outcome-a much lighter, more stable, softer crisp than with no addition or with either ingredient alone. The synergistic effects of lower pH and lecithin appear to promote cohesion, melt, solubility, and expansion of the product without dramatically increasing the internal viscosity.

It should be noted that in addition to the product of the invention being noticeably less dense, it also has smaller cell walls surrounding the air pockets that develop during extrusion, giving the crisp a more delicate texture.

Extruders basically comprise four components-a delivery system, a preconditioner, a barrel, and a knife or other type of cutting mechanism. The delivery system uniformly delivers the ingredients to the preconditioner. In the method of the invention, raw materials (pea protein, an acidulant, lecithin) are placed into the delivery system to be fed into the preconditioner, where the ingredients are hydrated and warmed. The combination of hydration and heating promotes chemical and conformational changes in the protein.

The barrel comprises screws, sleeves, barrel heads, and dies. The extruder may be categorized as twin-screw or single-screw, depending upon whether there are two parallel shafts within the barrel (twin-screw) or only one shaft (single-screw). The shaft, or screw, operates to move the material from the end of the barrel that is proximal to the preconditioner and operably (fluidly) connected to it, through the barrel, and to the end of the barrel that is distal to the preconditioner. At the distal end of the barrel is at least one die, and a component for cutting the extruded product.

The combination of adding moisture and heat, and the resulting pressure that builds up, naturally tends to denature, gel, or harden the protein product. The gelling and/or hardening makes it harder to move the material through the extruder barrel. So, conventional wisdom in protein extrusion has been to use conditions that discourage initial protein gelling and reduce product density in order to more smoothly move the ingredients through the extruder to produce the extrudate. However, the inventors have discovered that the increase in initial viscosity produced by pre-conditioning the product with lecithin actually helps to promote the development of a light, less dense protein crisp.

Pea proteins (PP) have a high solubility at pH values well above or below their isoelectric point of about 4.3 (e.g., about 80% at pH 2 and 9), whereas only 30% of PP are soluble at pH around 5. (Doan, C. D. et al., Formation and Stability of Pea Proteins Nanoparticles Using Ethanol-Induced Desolvation, Nanomaterials (Basel) 2019 July; 9(7): 949.) Extruded pea protein also tends to have increased gelling affinity and higher viscosity at lower pH. This increased gelling affinity and higher viscosity would generally cause the crisp to be denser, have a harder shell, and be less stable during extrusion. The method of the present invention solves that problem and produces light crisps that are quite suitable for consumption as-is or for use in a variety of products where they increase the overall protein content of the products while adding desirable characteristics to those products, as well.

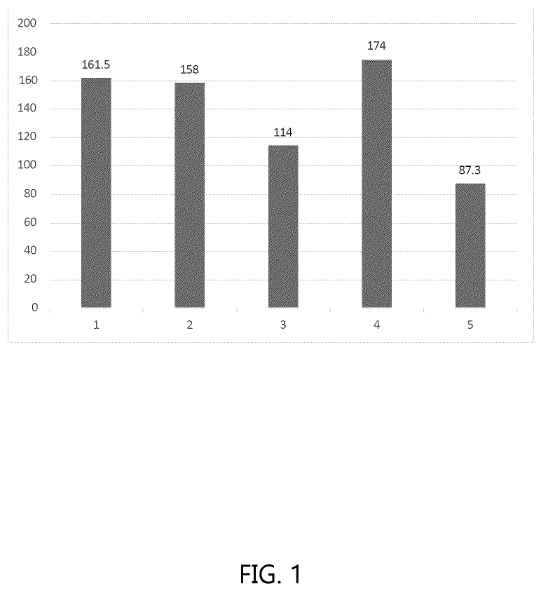

In a side-by-side comparison, the inventors used similar formulations and processing conditions to produce pea protein crisps from pea protein without lecithin, pea protein with lecithin, pea protein without lecithin, pea protein with citric acid, and pea protein with both lecithin and citric acid added to the dough formula. Density of products was measured, and results are shown below in Table 1. Those results are also shown in the graph in FIG. 1.

TABLE 1
Comparison of Product Density, Extruded Protein Crisps

| | Resulting |
|---|---|
| Formula | Product Density |
| Pea Protein without | 161.5 g/500 ml |
| Lecithin or Citric | |
| Acid (Control) | |
| Pea protein without | 158 g/500 ml |
| Lecithin or Citric | |
| Acid (Control Duplicate | |
| Using Different | |
| Lot of Pea Protein) | |
| Pea Protein | 114 g/500 ml |
| with Lecithin | |
| Pea Protein with | 174 g/500 ml |
| Citric Acid | |
| Pea protein Both | 83.7 g/500 ml |
| Lecithin and | |
| Citric Acid | |

As these results indicate, product density was very significantly reduced using the synergistic effects of lecithin and acidulant to provide a pH that is between the isoelectric point of pea protein and neutral pH, producing a lighter, more delicately crisp pea protein crisp.

The inventors noted that the ingredients should be fed into the extruder at a rate that quickly solubilizes the protein with the added water. Once solubilized, a pH-assisted gel will more readily form, inhibiting the unmodified protein from absorbing more water and allowing for more conformational changes of the proteins involved. The increased solubility, which appears to be provided by the presence of the lecithin in the ingredient formulation, prevents significant viscosity increase while encouraging a stable and fluid flow as the temperature increases. The presence of an acidulant (e.g., citric acid) reduces the variability in gel formation that is commonly associated with the use of pea protein concentrates. The acid also appears to promote formation of a firm gel as temperatures within the extruder begin to fall, preventing tearing and inconsistency. As temperature initially rises, increases in viscosity tend to cause soft, unstable foams or masses which can readily tear and prevent consistent stuffing pressure.

Pea proteins are associated with a significant amount of variability in initial viscosity changes during the heating process. The inventors have discovered that the addition of an acidulant increases gel affinity of the pea protein ingredients, with a pH of between about the isoelectric point of pea protein and about neutral pH (e.g., at about pH 7) promoting sufficient gelation to solve the problem without encouraging gelling or tearing in the extrusion head. Preferably, the pH is from about 5.20 to about 5.95, with a pH at or about 5.5 being particularly effective in many cases.

The inventors have also discovered that this combination can be even more effective if pea starches and fibers are present in the ingredient mix, as they also appear to act synergistically with lecithin to promote early viscosity. Although this early increase in viscosity seems counterintuitive in a process that involves trying to smoothly move the dough through the extruder, the inventors have discovered that a viscosity increase at this stage of the process (i.e., preconditioning/initial extrusion) can strengthen and provide elasticity to a gel that is being formed as temperatures cool. This process will promote an increase of force through the screw as early viscosity increases, and as viscosity is increased in the early (proximal) portion of the screw, added force will promote increased pressure near the die, as well as promoting increased mechanical energy within the system-improving cohesion and puffing as the protein begins to fully gel. The synergistic effect provided by the lecithin/pH combination provides a viscosity build-up at the proximal end of the screw while allowing for more mechanical energy and heat to be applied by the end of the die without clogging the unit as the resulting product is forced through the die and the product is cut, oven dried, and collected by standard methods used in the industry.

Extrusion equipment suitable for performing the method is commercially available from a variety of sources, such as the Magnum ST twin screw series of extruders from Wenger Manufacturing (Sabetha, Kansas USA) and extrusion parameters are readily determined by those of skill in the art, based on the equipment being used, manufacturer instructions, variation of ingredients used by an individual formulator, etc. Standard extrusion conditions for pea protein crisps generally include, for example, die pressure of approximately 80-160 psi, extrusion temperatures in the sequential zones of the extruder of about 115 degrees Fahrenheit for Zone 1, 210° F. for Zone 2, 245° F. for Zone 3, and 285° F. for Zone 4, with approximate throughput on a Magnum ST 55 (Wenger) of 110 lbs/hour.

The present method, and products made by the method, are described herein using the term “comprising.” However, it should be understood that “comprising” encompasses within its bounds the more narrowly-interpreted terms “consisting of” and “consisting essentially of.” Therefore, where the scope of the claims is intended to be more narrowly described, the terms “consisting essentially of” and “consisting of” may be used as a substitute for the broader term “comprising.” Where upper limits, lower limits, ranges, etc., are provided herein, it should also be understood that subranges exist within those expressed ranges and where desired, the invention may also more narrowly be described by those subranges. The method of the invention can be further described by means of the following non-limiting examples.

### EXAMPLES

### Effect of Citric Acid on Extruded Pea Protein Crisps

Pea protein powders were blended with citric acid at a ratio of 89% Pea Protein Concentrate (PPC-80% protein), 10% PPC containing fiber and starch (55% protein), and 1% citric acid to investigate the effect of mild pH reduction on dough viscosity. The powder was then preconditioned with water and heat, allowing the pea proteins and starches time to hydrate. Extrusion was performed using the following parameters: die pressure of approximately 80-160 psi, extrusion temperatures in the sequential zones of the extruder of about 115 degrees Fahrenheit for Zone 1, 210° F. for Zone 2, 245° F. for Zone 3, and 285° F. for Zone 4, with approximate throughput on a Magnum ST 55 (Wenger) of 110 lbs/hour. Viscosity measurements were made using a Rapid Visco Analyzer (RVA) according to standard methods. Results are shown in Table 2.

TABLE 2
Rapid Visco Analyzer (RVA) Measurement
Adjustment of Pea protein Concentrate with Citric Acid

| | Viscosity (Pa) | | | Stress (Pa) | | |
|---|---|---|---|---|---|---|
| | Max | Average | Final | Max | Average | Final |
| Control | 0.155 | 0.098 | 0.136 | 0.288 | 0.162 | 0.243 |
| (No Citric Acid | | | | | | |
| Added) | | | | | | |
| 0.25% Citric Acid | 0.190 | 0.116 | 0.149 | 0.406 | 0.244 | 0.361 |
| 0.5% Citric Acid | 0.234 | 0.139 | 0.198 | 0.495 | 0.281 | 0.376 |
| 1% Citric Acid | 0.291 | 0.172 | 0.223 | 0.567 | 0.302 | 0.409 |

Texture analysis to evaluate hardness and bulk density was also performed, and those results are shown in Table 3.

TABLE 3
Texture Analysis and Attributes of Crisps Made with Pea
Protein Concentrate and Various Levels of Citric Acid

| | Hardness (g/sec) | | | Bulk |
|---|---|---|---|---|
| | | | Coefficient. | Density |
| | Average | S.D. | of Variation | (g/500 ml) |
| Control (No Citric | 4971 | 436 | 23.7 | 165.5 |
| Acid Added) | | | | |
| 0.25% Citric Acid | 4729 | 371 | 16.8 | 166.8 |
| 0.5% Citric Acid | 5382 | 428 | 17.6 | 174.4 |
| 1% Citric Acid | 5712 | 327.8 | 14.0 | 192.1 |

### Effect of Lecithin on Extruded Pea Protein Crisps

Pea protein powders were blended with sunflower lecithin at a ratio of 89% Pea Protein Concentrate (PPC-80% protein), 10% PPC containing fiber and starch (55% protein), and 1% sunflower lecithin. The powder was then preconditioned with water and heat, allowing the pea proteins and starches time to hydrate. Extrusion was performed using the following parameters: die pressure of approximately 80-160 psi, extrusion temperatures in the sequential zones of the extruder of about 115 degrees Fahrenheit for Zone 1, 210° F. for Zone 2, 245° F. for Zone 3, and 285° F. for Zone 4, with approximate throughput on a Magnum ST 55 (Wenger) of 110 lbs/hour. Viscosity measurements were made using a Rapid Visco Analyzer (RVA) according to standard methods. Results are shown in Table 4.

TABLE 4
Rapid Visco Analyzer (RVA) Measurement
Modification of Pea Protein Concentrate Dough with Lecithin

| | Viscosity (Pa) | | | Stress (Pa) | | |
|---|---|---|---|---|---|---|
| | Max | Average | Final | Max | Average | Final |
| Control | 0.137 | 0.085 | 0.127 | 0.255 | 0.141 | 0.227 |
| 0.25% Lecithin | 0.147 | 0.089 | 0.123 | 0.314 | 0.187 | 0.298 |
| 0.5% Lecithin | 0.207 | 0.119 | 0.157 | 0.438 | 0.241 | 0.298 |
| 1.0% Lecithin | 0.241 | 0.137 | 0.164 | 0.470 | 0.241 | 0.249 |

Texture analysis to evaluate hardness and bulk density was also performed, and those results are shown in Table 5.

TABLE 5
Texture Analysis and Attributes of Crisps Made with Pea
Protein Concentrate and Various Levels of Lecithin

| | Hardness (g/sec) | | | |
|---|---|---|---|---|
| | | | Coefficient | Bulk Density |
| | Average | S.D. | of Variation | (g/500 ml) |
| Control | 4830 | 521 | 25.8 | 161.5 |
| 0.25% Lecithin | 4415.58 | 363.58 | 16.7 | 147.2 |
| 0.5% Lecithin | 3959.64 | 291.742 | 15.3 | 132.8 |
| 1.0% Lecithin | 3552.72 | 436.56 | 18.2 | 114.0 |

### Effect of Combining Lecithin and Acid (e.g., Citric Acid) on Extruded Pea Protein Crisps

Pea protein powders were blended with sunflower lecithin and citric acid at a ratio of 88% Pea Protein Concentrate (PPC-80% protein), 10% PPC containing fiber and starch (55% protein), 1% sunflower lecithin, and 1% citric acid. The powder was then preconditioned with water and heat, allowing the pea proteins and starches time to hydrate. Extrusion was performed using the following parameters: die pressure of approximately 80-160 psi, extrusion temperatures in the sequential zones of the extruder of about 115 degrees Fahrenheit for Zone 1, 210° F. for Zone 2, 245° F. for Zone 3, and 285° F. for Zone 4, with approximate throughput on a Magnum ST 55 (Wenger) of 110 lbs/hour. Viscosity measurements were made using a Rapid Visco Analyzer (RVA) according to standard methods. These results are compared with those of a control (no lecithin, no citric acid added) and a product made by adding 1% citric acid and no lecithin, as listed in Table 6.

TABLE 6
Rapid Visco Analyzer (RVA) Measurement
Modification of Pea Protein Concentrate
Dough with Lecithin and Citric Acid

| | Viscosity (Pa) | | | Stress (Pa) | | |
|---|---|---|---|---|---|---|
| | Max | Average | Final | Max | Average | Final |
| Control | 0.161 | 0.096 | 0.132 | 0.32 | 0.179 | 0.256 |
| 1% Citric | 0.214 | 0.115 | 0.163 | 0.477 | 0.262 | 0.415 |
| 0% Lecithin | | | | | | |
| 1% Citric + | 0.280 | 0.162 | 0.170 | 0.612 | 0.348 | 0.343 |
| 1% Lecithin | | | | | | |

Texture analysis to evaluate hardness and bulk density was also performed, and those results are compared with those of a control product made without the addition of either citric acid or lecithin and a product made with 1% citric acid and no added lecithin, and listed in Table 7. Texture analysis to evaluate hardness and bulk density was also performed at various protein levels, and those results are compared with those of a control product made without the addition of either citric acid or lecithin, as shown in Table 8.

TABLE 7
Texture Analysis and Attributes of Crisps Made with Pea
Protein Concentrate and Various Levels of Lecithin

| | Hardness (g/sec) | | | |
|---|---|---|---|---|
| | | | Coefficient. | Bulk Density |
| | Average | S.D. | of Variation | (g/500 ml) |
| Control | 4645 | 326 | 15.3 | 158.3 |
| 1% Citric | 2685 | 412 | 19.5 | 189.0 |
| 0% Lecithin | | | | |
| 1% Citric | 1986.4 | 430 | 19.6 | 83.7 |
| 1% Lecithin | | | | |

TABLE 8
Texture Analysis and Attributes of Crisps Made with various levels of
protein with and without the presence of citric acid and lecithin

| | Hardness (g/sec) | | | |
|---|---|---|---|---|
| | | | Coefficient. | Bulk Density |
| | Average | S.D. | of Variation | (g/500 ml) |
| 65% Protein Pea | 2478 | 259 | 14.2 | 120.8 |
| Crisp Control | | | | |
| 65% Protein Pea Crisp | 1806 | 231 | 23.8 | 87.3 |
| containing citric | | | | |
| acid and lecithin | | | | |
| 70% Protein Pea | 3618 | 344 | 17.9 | 140.2 |
| Crisp Control | | | | |
| 70% Protein Pea Crisp | 2190 | 310 | 18.6 | 93.0 |
| containing citric | | | | |
| acid and lecithin | | | | |
| 75% Protein Pea | 4901 | 523 | 19.4 | 161.5 |
| Crisp Control | | | | |
| 75% Protein Pea Crisp | 3648 | 454 | 21.0 | 110.2 |
| containing citric | | | | |
| acid and lecithin | | | | |

### Effect of Combining Lecithin and Acid (e.g., Citric Acid) on Extruded Pea, Faba, and Soy Protein Crisps

Various protein isolates were blended with the defined level of lecithin, PPC containing fiber, and citric acid if appropriate to produce crisps with 75% protein from the various ingredient sources. These sources included Faba Protein Soy protein and Pea protein Isolate. The powder was then preconditioned with water and heat, allowing the pea proteins and starches time to hydrate. Extrusion was performed using the following parameters: die pressure of approximately 80-160 psi, extrusion temperatures in the sequential zones of the extruder of about 115 degrees Fahrenheit for Zone 1, 210° F. for Zone 2, 245° F. for Zone 3, and 285° F. for Zone 4, with approximate throughput on a Magnum ST 55 (Wenger) of 110 lbs/hour. Viscosity measurements were made using a Rapid Visco Analyzer (RVA) according to standard methods. Texture analysis to evaluate hardness and bulk density was also performed, and those results are compared with those of a control product made without the addition of either citric acid or lecithin, as shown in Table 9.

TABLE 9
Texture Analysis and Attributes of Crisps Made with various protein
types with and without the presence of citric acid and lecithin

| | Hardness (g/sec) | | | Bulk |
|---|---|---|---|---|
| | | | Coefficient. | Density |
| | Average | S.D. | of Variation | (g/500 ml) |
| Pea Protein Isolate control* | 4901 | 523 | 19.4 | 161.5 |
| Pea Protein crisp containing | 3648 | 454 | 21.0 | 110.2 |
| citric acid and lecithin | | | | |
| Faba protein crisp control | 2427 | 219.2 | 16.9 | 126.3 |
| Faba protein crisp containing | 1704 | 261 | 19.0 | 96.1 |
| citric acid and lecithin | | | | |
| Soy protein crisp control | 1821.8 | 184.5 | 20.7 | 102.2 |
| Soy protein crisp containing | 1560.8 | 166.4 | 22.5 | 80.0 |
| citric acid and lecithin | | | | |

*same sample as Table 8 75% protein pea crisp control

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method for producing extruded protein crisps, the method comprising adding to a protein crisp ingredient mix an effective amount of at least one acidulant to reduce the pH of a dough formed by the ingredient mix and at least one lecithin component and extruding the dough to produce the extruded protein crisps.

2. The method of claim 1, wherein the extruded protein crisps comprise at least one of pea protein crisps, faba protein crisps, or soy protein crisps.

3. The method of claim 1, wherein the at least one acidulant is selected from the group consisting of citric acid, phosphoric acid, lactic acid, fumaric acid, calcium citrate, malic acid, potassium citrate, sodium citrate and tartaric acid.

4. The method of claim 3, wherein the at least one acidulant is citric acid.

5. The method of claim 1, wherein the effective amount of acidulant is at least 0.5 percent acid.

6. The method of claim 1, wherein the effective amount of acidulant is at least 1.0 percent acid.

7. The method of claim 1, wherein the at least one lecithin component is selected from the group consisting of soybean lecithin, canola lecithin, and sunflower lecithin.

8. The method of claim 7, wherein the at least one lecithin component is soybean lecithin.

9. The method of claim 1, further comprising the step of adding to the ingredient mix at least one source of fiber and/or starch.

10. The method of claim 9, wherein the at least one source of fiber and/or starch is a pea protein concentrate comprising pea protein, pea fiber, and/or pea starch.

11. The method of claim 1, further comprising the step of milling the extruded protein crisps to reduce particle size and produce a protein powder.

12. The method of claim 1, wherein the extruded protein crisps are pea protein crisps having a density of about 83.7 g/500 ml or less.

13. A method for reducing the density of extruded protein crisps, the method comprising adding at least one acidulant and at least one lecithin component to an protein crisp ingredient mix comprising at least about 65 percent protein, the combination of the at least one acidulant and the at least one lecithin component modifying the viscosity of a dough formed from the protein crisp ingredient mix to produce a light, crisp protein crisp of reduced density as compared that of a protein crisp made without the at least one acidulant and the at least one lecithin component.

14. The method of claim 13, wherein the extruded protein crisps comprise at least one of pea protein crisps, faba protein crisps, or soy protein crisps.

15. The method of claim 13, wherein the ingredient mix comprises at least about 70 percent protein.

16. The method of claim 13, wherein the ingredient mix comprises at least about 75 percent protein.

17. The method of claim 13, wherein the at least one acidulant is selected from the group consisting of citric acid, phosphoric acid, lactic acid, fumaric acid, calcium citrate, malic acid, potassium citrate, sodium citrate and tartaric acid.

18. The method of claim 17, wherein the at least one acidulant is citric acid.

19. The method of claim 13, wherein the at least one lecithin component is selected from the group consisting of soybean lecithin, canola lecithin, and sunflower lecithin.

20. The method of claim 19, wherein the at least one lecithin component is soybean lecithin.

21. The method of claim 13, wherein the extruded protein crisps have a density of about 83.7 g/500 ml or less.
